(19) United States
(12) Patent Application Publication
(10) Pub. No.: US 2012/0306956 A1
(43) Pub. Date: Dec. 6, 2012

(54) HEAT CONTROL DEVICE OF INKJET HEAD AND CONTROL METHOD

(75) Inventors: Mamoru Kimura, Shizuoka (JP); Tetsuya Ishihara, Shizuoka (JP)

(73) Assignee: TOSHIBA TEC KABUSHIKI KAISHA, Tokyo (JP)

(21) Appl. No.: 13/486,258

(22) Filed: Jun. 1, 2012

(30) Foreign Application Priority Data
Jun. 6, 2011 (JP) 2011-126178
May 7, 2012 (JP) 2012-105970

(51) Int. Cl. B41J 29/38

(52) U.S. Cl. 347/14

(57) ABSTRACT

According to one embodiment, a heat control device of an inkjet head includes an inkjet head unit in which plural inkjet heads each including plural nozzles are arranged side by side, and a control part that performs multiphase-division driving of the nozzles and controls discharge of ink from the respective nozzles. The control part ON/OFF controls a precursor minute vibration for each line information set according to discharge pattern information irrespective of data information including the discharge pattern information to cause the respective nozzles corresponding to respective pixel data constituting a drawn image to discharge ink according to the pixel data.

### CROSS-REFERENCE TO RELATED APPLICATION

This application is based upon and claims the benefit of priority from the prior Japanese Patent Applications No.2011-126178 filed on Jun. 6, 2011 and No. 2012-105970 filed on May 7, 2012, the entire contents of which are incorporated herein by reference.

### FIELD

Embodiments described herein relate generally to a heat control device of an inkjet head and a control method.

### BACKGROUND

A piezoelectric inkjet head used in an inkjet printer is a heating element, and the temperature of the inkjet head is a parameter to affect ink discharge performance.

Besides, ink degradation also significantly affects the ink discharge performance.

Hitherto, in an inkjet head, heat is applied in a period between sheets to prevent ink thickening (see, for example, JP-A-2008-126535). In the inkjet head, a precursor minute vibration is applied to the ink in the period between sheets conveyed in an inkjet printer. The precursor minute vibration is applied to the ink in the inkjet head in order to prevent ink degradation, that is, ink thickening. When a piezoelectric element applies the precursor minute vibration to the ink, heat is generated by the driving of the piezoelectric element and the ink is heated.

In order to apply the heat in the period between sheets, for example, heat ON/OFF is required to be retransmitted to a register, and must be retransmitted while the register is cleared by a RESET command. Thus, image data is also cleared, and accordingly, this operation is hard to perform during printing.

Besides, since the heat is uniformly applied to the inkjet head, there is a problem that a temperature rise rate of a nozzle having a high use frequency becomes high as compared with a nozzle having a low use frequency.

### BRIEF DESCRIPTION OF THE DRAWINGS

FIG. 1 is a block diagram showing a main part of a precursor minute vibration control circuit in a heat control device of an inkjet head of an embodiment.

FIG. 2 shows an example of a timing chart showing waveforms of main signals and their relation.

### DETAILED DESCRIPTION

According to one embodiment, a heat control device of an inkjet head includes an inkjet head unit in which plural inkjet heads each including plural nozzles are arranged side by side, and a control part that performs multiphase-division driving of the nozzles and controls discharge of ink from the respective nozzles. The control part ON/OFF controls a precursor minute vibration for each line information set according to discharge pattern information irrespective of data information including the discharge pattern information to cause the respective nozzles corresponding to respective pixel data constituting a drawn image to discharge ink according to the pixel data.

Hereinafter, an embodiment will be described with reference to the drawings. Incidentally, in the respective drawings, the same component is denoted by the same reference numeral, and a duplicate description is omitted.

A share mode and share wall inkjet head used in an inkjet printer includes an insulating substrate made of a ceramic material, a nozzle plate arranged to face the insulating substrate, a driving element laminated and arranged between the insulating substrate and the nozzle plate, and a frame member that is made of a ceramic material and surrounds the driving element to forma common liquid chamber and a pressure chamber.

The driving element includes a pair of piezoelectric element (piezo element) made of a PZT (lead zirconate titanate) piezoelectric ceramic material. Incidentally, the driving element is driven by a driving circuit, and an electrode pattern to electrically connect the driving element to the driving circuit is formed on the insulating substrate. Besides, taper faces are formed on both end faces of the driving element.

In the share mode and share wall inkjet head, ink is selectively discharged from plural nozzles and an image is formed on a sheet. In order to increase the fluidity of ink in a still state and to improve the intermittent discharge performance, a piezoelectric element of a resting nozzle, which does not discharge an ink droplet during the discharge operation of the inkjet head, is made to perform precursor minute vibration. The precursor minute vibration is an operation to previously vibrate a meniscus of ink to such a degree that the ink is not discharged from the nozzle. When the precursor minute vibration is frequently performed, the head temperature rises and the ink is degraded.

In this embodiment, the precursor minute vibration is ON/OFF controlled for each line irrespective of a data line indicating discharge information to cause the respective nozzles corresponding to respective pixel data corresponding to plural pixels constituting an image to discharge ink according to the pixel data. Besides, irrespective of the data line, the period of the precursor minute vibration is set and the ON/OFF control is performed. Further, while the temperature of the inkjet head is detected, the precursor minute vibration is ON/OFF controlled. The “line” will be described later.

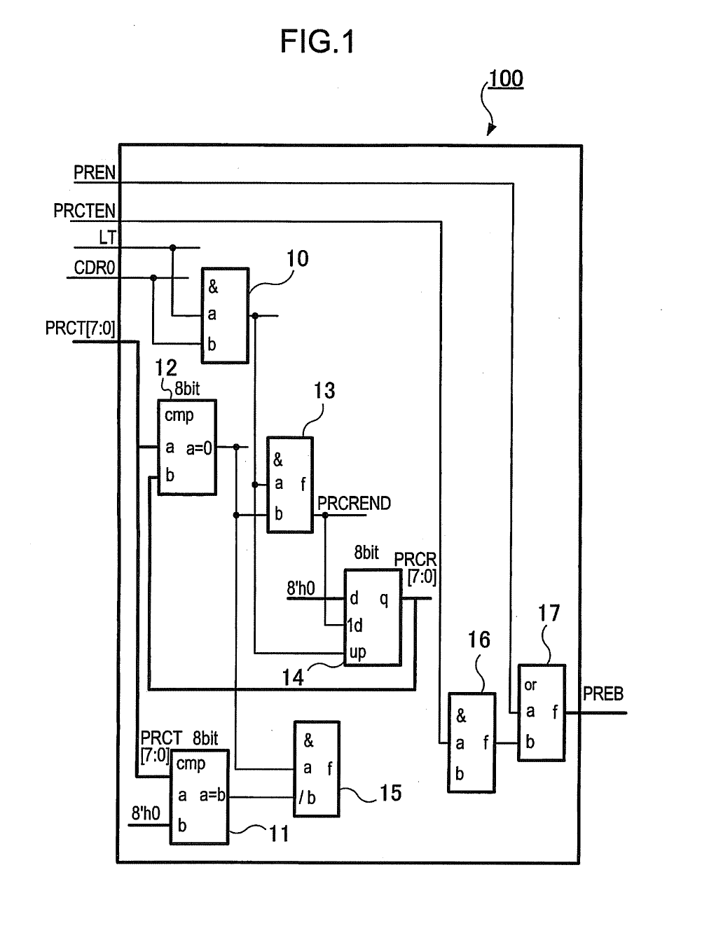

FIG. 1 is a block diagram showing a main part of a precursor minute vibration control circuit in a heat control device of an inkjet head of an embodiment. In this embodiment, the control circuit shown in FIG. 1 is provided in a driver IC to drive the inkjet head, and the respective nozzles of the inkjet head are controlled. Even in the middle of continuing formation of an image, a flag of an external command is set, so that the precursor minute vibration is ON/OFF controlled for each line. Besides, the precursor minute vibration is periodically ON/OFF controlled at a set period.

As shown in FIG. 1, the precursor minute vibration control circuit captures a PREN signal to enable precursor minute vibration, an LT signal generated for each line and indicating a timing, a CDR0 signal indicating a command to control a line with respect to the precursor minute vibration, a PRCT signal indicating a set value for setting a generation period of a heat pulse to turn ON the precursor minute vibration, a PRCTEN signal to ON/OFF control the periodic operation itself of the heat pulse, a PREB signal indicating an output from a block representing the main part of the control circuit, and a count value represented by a hexadecimal number of 8 bits.

As shown in FIG. 1, the LT signal and the CDR0 signal are inputted to an AND circuit 10, a logical product (AND) is taken, and the result thereof is outputted as an LTS signal. The PRCT signal and the count value represented by the hexadecimal number of 8 bits are inputted to an 8-bit comparator 11.

Besides, the PRCT signal and an after-mentioned PRCR signal are inputted to an 8-bit data comparator 12. The LTS signal as the output of the AND circuit 10 and the comparison result of the comparator 12 are inputted to an AND circuit 13 . A logical product (AND) of the AND circuit 13 is inputted as a PRCREND signal to an 8-bit data counter 14. The LTS signal as the output of the AND circuit 10 and the count value represented by the hexadecimal number of 8 bits are also inputted to the counter 14, and the 8-bit count value PRCR as the output is inputted to the comparator 12. The comparison result of the 8-bit comparator 11 and the comparison result of the comparator 12 are inputted to an AND circuit 15.

Besides, the PRCTEN signal and the output from the AND circuit 15 are inputted to an AND circuit 16 and a logical product (AND) is taken. Further, the PREN signal and the output signal of the AND circuit 16 are inputted to an OR circuit 17, a logical sum (OR) is taken, and the PREB signal indicating the output from this block is outputted.

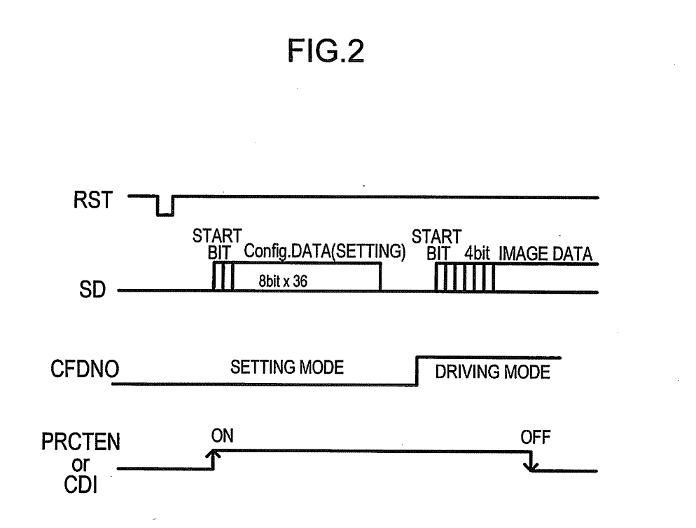

FIG. 2 shows an example of a timing chart showing waveforms of main signals and a relation therebetween. FIG. 2 shows the waveforms of an RST signal to reset the precursor minute vibration control circuit, an SD signal as a data stream of print contents, a CFDNO signal indicating setting/driving of the precursor minute vibration control, and the PRCTEN signal or a CDI signal indicating command data, and the relation therebetween. Incidentally, this timing chart is an example, and no limitation is made to this.

Next, the line will be described. The following description is merely an example, and no limitation is made to this.

The inkjet head includes ink discharge ports arranged in plural lines, and discharge is sequentially and repeatedly performed for each of the lines. A nozzle plate part bonded to a piezoelectric ceramic is divided by, for example, three periods of A-phase, B-phase, C-phase, A-phase . . . , and is divided, in terms of time, into three parts. Nozzle holes of the respective nozzles are offset for each discharge phase, and are shifted at every three cycles.

After voltage application (active operation) in the direction of widening the piezoelectric ceramic at both sides in contact with the A-phase is performed, voltage application (inactive operation) in the direction of contracting the piezoelectric ceramic at both sides in contact with the A-phase is performed, so that ink is discharge from the A-phase nozzle hole. At this time, discharge from the adjacent B-phase and C-phase is prevented. After the discharge from the A-phase, a pause is taken until the residual vibration attenuates and disappears.

Hereafter, the discharge phase shifts to the B-phase and the C-phase, and ink droplets can be discharged from all nozzles. As stated above, the three-phase division driving of repeating A→B→C→A . . . is performed. The control part to drive and control the inkjet head includes buffers (hereinafter referred to as line buffers) corresponding to the A-phase, the B-phase and the C-phase, and the line buffers of the respective phases mutually transmit information.

After discharge of ink from the C-phase ink discharge port is ended, a determination is made as to whether the discharge is performed the number of times of lines set in a line counter to count lines. If the discharge is not performed the set number of times of lines, the discharge pattern information is transferred to the A-phase line buffer.

The A-phase ink discharge port again starts to discharge based on the discharge pattern information, the foregoing operation is repeatedly performed the number of lines, and a desired print pattern is formed. The discharge pattern information is information for drawing, and is formed by, for example, calculating a discharge pattern for obtaining a desired print pattern from the arrangement position of the inkjet head.

According to the embodiment, with respect to ON/OFF of heat to a not-driven nozzle, since the ON/OFF control can be performed also during printing in addition to a period between sheets, the heat control is performed while the temperature of the inkjet head is detected, and excessive temperature rise of the inkjet head can be prevented.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A heat control device of an inkjet head, comprising:
an inkjet head unit in which a plurality of inkjet heads each including a plurality of nozzles are arranged side by side; and
a control part that performs multiphase-division driving of the nozzles and controls discharge of ink from the respective nozzles, wherein
the control part ON/OFF controls a precursor minute vibration for each line information set according to discharge pattern information irrespective of data information including the discharge pattern information to cause the respective nozzles corresponding to respective pixel data constituting a drawn image to discharge ink according to the pixel data.

2. The device of claim 1, wherein the discharge pattern information is generated by calculating a discharge pattern for obtaining a desired print pattern from an arrangement position of the inkjet heads.

3. The device of claim 1, wherein the line information is managed by counting multiphase-divided lines.

4. The device of claim 1, wherein a period of the precursor minute vibration is set irrespective of the data information, and heat is periodically applied to the nozzles.

5. The device of claim 4, wherein the period can be set based on a set value for setting a generation period of a heat pulse to turn ON the precursor minute vibration.

6. The device of claim 4, wherein the periodic operation can be turned ON/OFF.

7. The device of claim 1, wherein management of the line information is performed by a first signal generated for each line and indicating a timing and a second signal indicating a command to manage the line information with respect to the precursor minute vibration.

8. The device of claim 1, further comprising a detection part to detect temperature of the inkjet head, wherein the precursor minute vibration is ON/OFF controlled according to a detection result.

9. The device of claim 1, wherein the inkjet head is a piezoelectric inkjet head including a piezoelectric ceramic as an actuator.

10. The device of claim 2, wherein management of the line information is performed by a first signal generated for each line and indicating a timing and a second signal indicating a command to manage the line information with respect to the precursor minute vibration.

11. The device of claim 2, further comprising a detection part to detect temperature of the inkjet head, wherein the precursor minute vibration is ON/OFF controlled according to a detection result.

12. The device of claim 2, wherein the inkjet head is a piezoelectric inkjet head including a piezoelectric ceramic as an actuator.

13. The device of claim 3, wherein management of the line information is performed by a first signal generated for each line and indicating a timing and a second signal indicating a command to manage the line information with respect to the precursor minute vibration.

14. The device of claim 3, further comprising a detection part to detect temperature of the inkjet head, wherein the precursor minute vibration is ON/OFF controlled according to a detection result.

15. A heat control method of a heat control device of an inkjet head provided with an inkjet head unit in which a plurality of inkjet heads each including a plurality of nozzles are arranged side by side, and a control part that performs multiphase-division driving of the nozzles and controls discharge of ink from the respective nozzles, the heat control method comprising:
generating data information including discharge pattern information to cause the respective nozzles corresponding to respective pixel data constituting a drawn image to discharge ink according to the pixel data; and
ON/OFF controlling a precursor minute vibration for each line information set according to the discharge pattern information.

16. The method of claim 15, wherein
a period of the precursor minute vibration is set, and
heat is periodically applied to the nozzles.

17. The method of claim 16, wherein the period is set based on a set value for setting a generation period of a heat pulse to turn ON the precursor minute vibration.

18. The method of claim 16, wherein the periodic operation can be turned ON/OFF.

19. The method of claim 15, wherein the discharge pattern information is generated by calculating a discharge pattern for obtaining a desired print pattern from an arrangement position of the inkjet heads.

20. The method of claim 15, wherein the line information is managed by counting multiphase-divided lines.
